(19) United States
(12) Patent Application Publication
(10) Pub. No.: US 2023/0103103 A1
(43) Pub. Date: Mar. 30, 2023

(54) PROCESS FOR OPTIMIZING THE OPERATION OF A COMPUTER IMPLEMENTING A NEURAL NETWORK

(71) Applicant: Commissariat à l'énergie atomique et aux énergies alternatives, Paris (FR)

(72) Inventors: Vincent LORRAIN, Gif Sur Yvette Cedex (FR); Johannes Christian THIELE, Gif Sur Yvette Cedex (FR)

(73) Assignee: Commissariat à l'énergie atomique et aux énergies alternatives, Paris (FR)

(21) Appl. No.: 17/952,849

(22) Filed: Sep. 26, 2022

(30) Foreign Application Priority Data
Sep. 27, 2021 (FR) 21 10153

(51) Int. Cl. G06N 3/08

(52) U.S. Cl. CPC G06N 3/08

(57) ABSTRACT

A method is provided for optimizing the operation of a calculator implementing a neural network, the method comprising providing a neural network, providing training data relating to the values taken by the neural network parameters during a training of the neural network on a test database, determining, depending on the training data, an implementation of the neural network on hardware blocks of a calculator so as to optimize a cost relating to the operation of said the calculator implementing the neural network, the implementation being determined by decomposing the values of the neural network parameters into sub-values and by assigning to every sub-value, one hardware block from a set of hardware blocks of the calculator, and the operation of the calculator with the determined implementation.

The present invention relates to a method for optimizing the operation of a calculator implementing a neural network. The present invention further relates to an associated computer program product. The present invention further relates to an associated readable information medium.

Machine learning systems are used in many applications. Such systems are in particular based on neural networks previously trained on a training database. The task for which the neural network was trained is then performed during an inference step.

And yet, such systems are very resource-intensive because of the large number of arithmetic operations, called multiply accumulate (abbreviated as MAC), to be carried out for processing a datum. Such an energy consumption is in particular proportional to the number of bits needed for processing the datum. A large number of bits typically leads to a better performance of an application, but also requires more intensive computational operators and memory accesses.

Hence the need for a process for optimizing the performance of machine learning systems implementing a neural network.

To this end, the subject matter of the invention is a method for optimizing the operation of a calculator implementing a neural network, the method being implemented by computer and comprising the following steps:
a. providing a neural network, the neural network having parameters the values of which can be modified during a training of the neural network,
b. providing training data relating to the values taken by the neural network parameters during a training of the neural network on at least one test database,
c. determining, depending on the training data, an implementation of the neural network on hardware blocks of a calculator so as to optimize a cost relating to the operation of said calculator implementing the neural network, the implementation being determined by decomposing the values of the neural network parameters into sub-values and by assigning to every sub-value, at least one hardware block from a set of hardware blocks of the calculator, and
d. operating the calculator with the implementation determined for the neural network.

According to particular embodiments, the method comprises one or a plurality of the following features, taken individually or according to all technically possible combinations:
the values of every parameter are each suitable for being represented by a sequence of bits, every bit of a sequence having a different weight according to the position of the bit in the sequence, the bit having the greatest weight being called the most significant bit, the sub-values resulting from the same decomposition being each represented by a sequence of one or more bits;
every value of a parameter results from a mathematical operation, such as addition, a concatenation or a multiplication, on the sub-values of the corresponding decomposition;
during the operation step, the sub-values of every decomposition are each multiplied to an input value and the results of the resulting multiplications are summed or accumulated for obtaining a final value, the output or outputs of the neural network being obtained according to the final values;
during the operation step, a mathematical operation is applied to the sub-values of every decomposition so as to obtain an intermediate value, the intermediate value being the value of the parameter corresponding to the decomposition, the intermediate value then being multiplied by an input value for obtaining a final value, the output(s) of the neural network being obtained according to the final values;
the mathematical operation is an addition, a concatenation or a multiplication of the sub-values of every decomposition so as to obtain the value of the corresponding parameter;
the cost to be optimized uses at least one performance metric of the calculator implementing the neural network during a subsequent training of the neural network on another database, the initial values of the neural network parameters during a subsequent training being defined according to the training data;
the cost to be optimized uses at least one performance metric of the calculator implementing the neural network during a subsequent inference of the neural network after a subsequent training of the neural network on another database, the initial values of the neural network parameters during the subsequent training being defined according to the training data;
the training data comprise the different values taken by the parameters during the training on the at least one test database, the decomposition of the parameter values into sub-values is determined according to the frequency of change and/or the amplitude of change of said values in the training data;
the cost to be optimized uses at least one performance metric of the calculator implementing the neural network during an inference of the neural network by considering only part of the sub-values of every decomposition, the values of the neural network parameters having been set according to the training data;
the cost to be optimized uses at least one performance metric of the calculator, the at least one performance metric being chosen from: the latency of the calculator on which the neural network is implemented, the energy consumption of the calculator on which the neural network is implemented, the number of inferences per second during the inferences of the neural network implemented on the calculator, the quantity of memory used by all or part of the sub-values of the decomposition, and the surface area after manufacture of the integrated circuit embedding the calculator;
the assignment of every hardware block to a sub-value is performed according to the position of the hardware block in the calculator and/or to the type of the hardware block among the hardware blocks performing a storage function and/or to the type of the hardware block among the hardware blocks performing a calculation function.

The present description further relates to a computer program product comprising a readable information medium, on which a computer program is stored comprising program instructions, the computer program being loadable on a data processing unit and leading to the implementation of a method as described above when the computer program is run on the data processing unit.

The present description further relates to a readable information medium on which a computer program product as described above is stored.

Other features and advantages of the invention will appear upon reading hereinafter the description of the embodiments of the invention, given only as an example, and making reference to the following drawings:

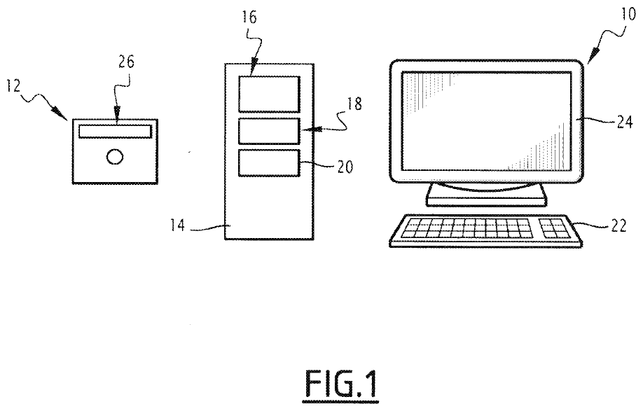

FIG. 1, a schematic view of an example of a calculator making possible the implementation of a method for optimizing the operation of a calculator implementing a neural network,

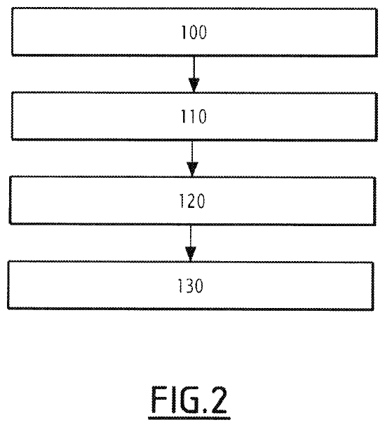

FIG. 2, an organization chart of an example of implementation of a method for optimizing the operation of a calculator implementing a neural network,

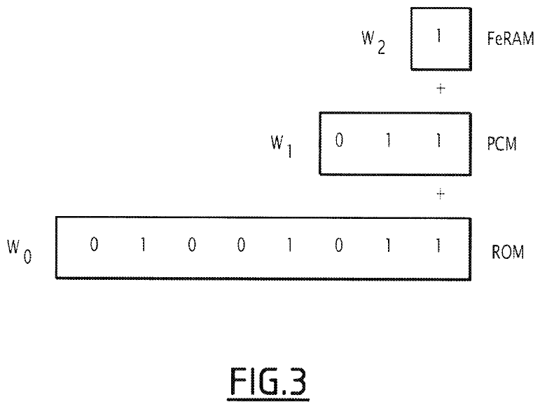

FIG. 3, a schematic representation of an example of an addition decomposition of a value of a parameter of the neural network, into sub-values

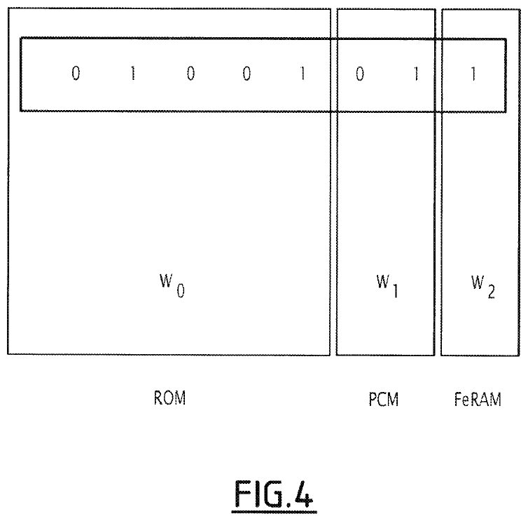

FIG. 4, a schematic representation of an example of concatenation decomposition of a value of a parameter of the neural network, into sub-values,

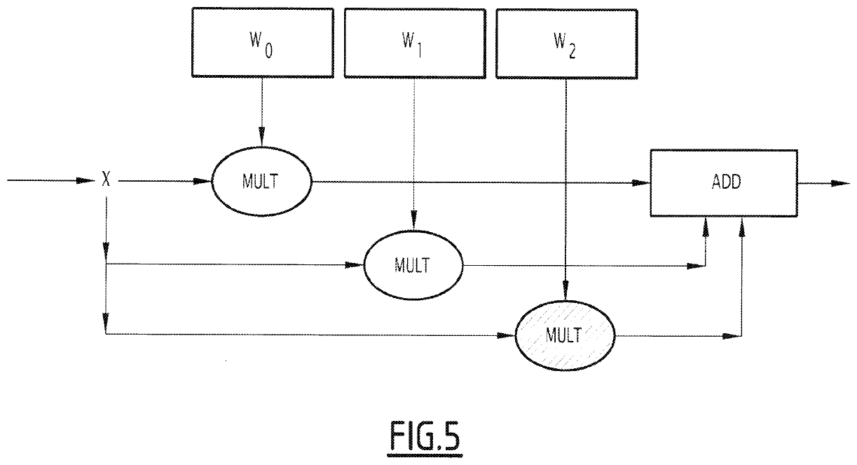

FIG. 5, a schematic representation of an example of calculation, called a pre-operator, during which the sub-values of an addition decomposition are each multiplied by an input value and the results of the resulting multiplications are summed for obtaining a final value,

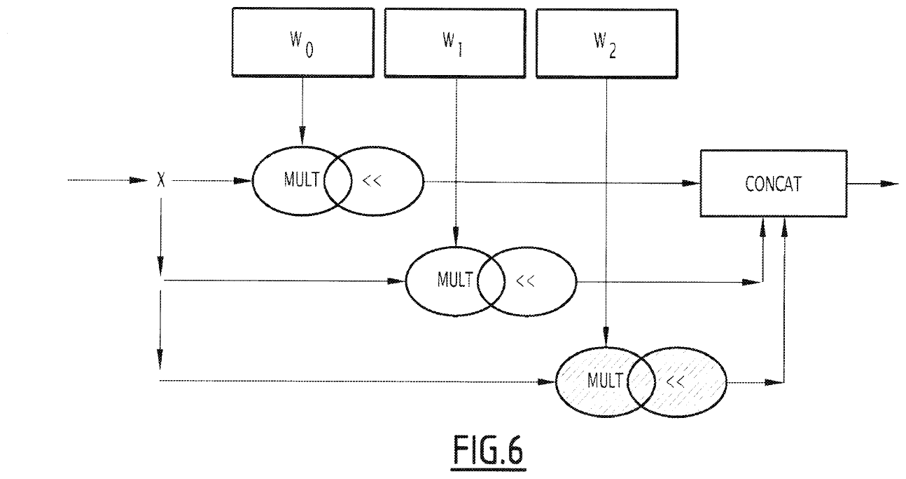

FIG. 6, a schematic representation of an example of calculation, called a pre-operator, in which the sub-values of a concatenation decomposition are each multiplied by an input value and the results of the resulting multiplications are concatenated (accumulated) for obtaining a final value,

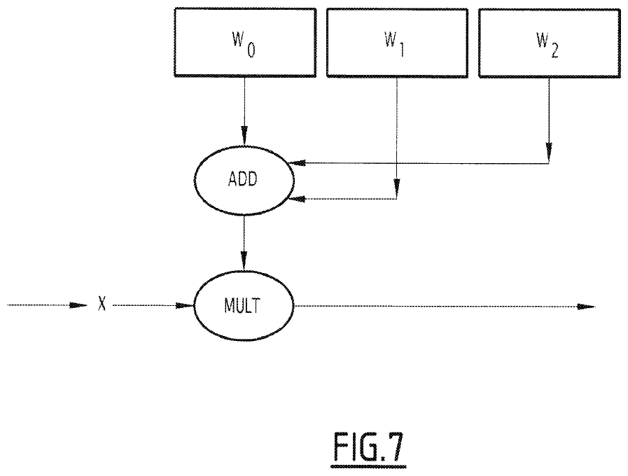

FIG. 7, a schematic representation of an example of calculation, called a post-operator, during which the sub-values of an addition decomposition are summed and the resulting sum is multiplied to an input value for obtaining a final value,

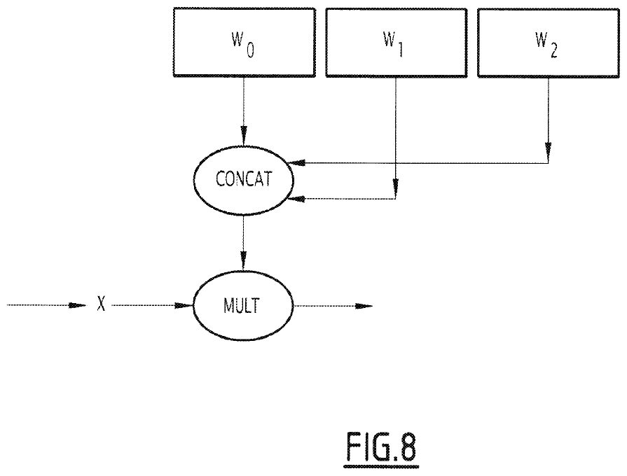

FIG. 8, a schematic representation of an example of calculation, called a post-operator, during which the sub-values of a concatenation decomposition are concatenated and the resulting concatenation is multiplied to an input value for obtaining a final value,

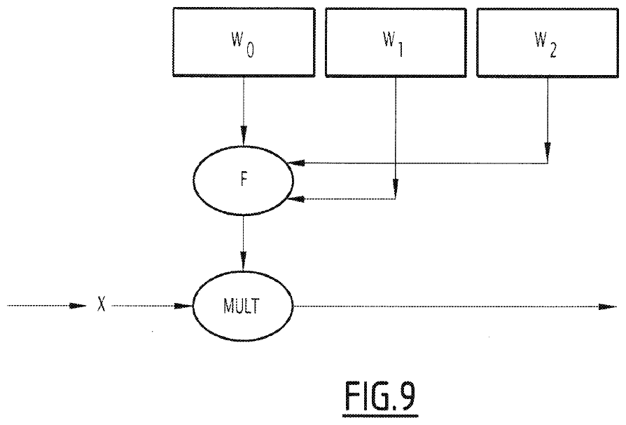

FIG. 9, a schematic representation of an example of calculation, called a post-operator, during which the sub-values of a decomposition are the inputs of a function suitable for supplying an intermediate value, the intermediate value being the value of the parameter corresponding to the decomposition, the intermediate value then being multiplied by an input value for obtaining a final value,

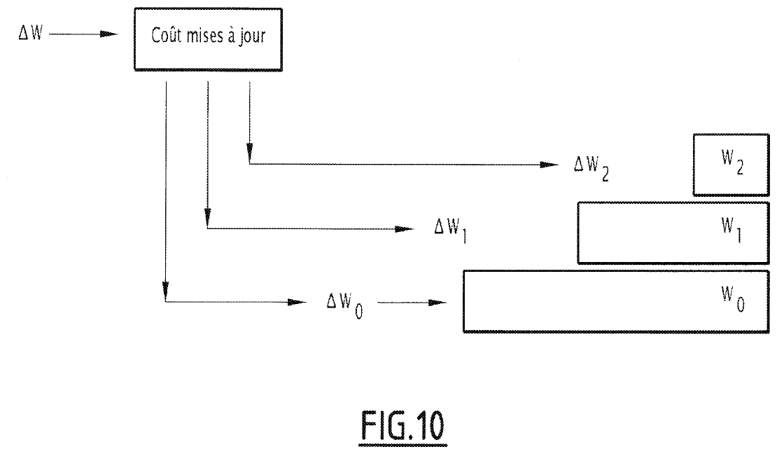

FIG. 10, a schematic representation of an example of updating the sub-values of an addition decomposition (or more generally a decomposition resulting from a mathematical operation) following a training of the neural network, and

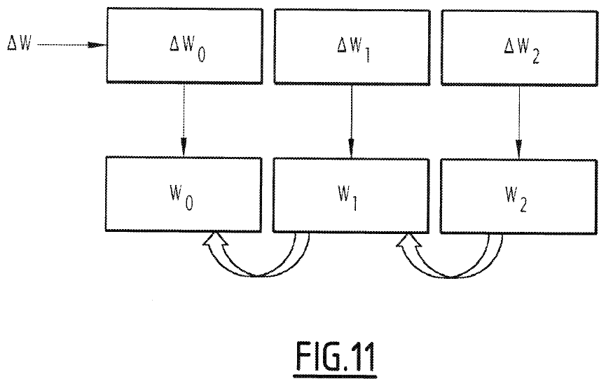

FIG. 11, a schematic representation of an example of updating the sub-values of a concatenation decomposition following a training of the neural network.

FIG. 1 illustrates a calculator 10 and a computer program product 12, used for implementing a method for optimizing the operation of a calculator implementing a neural network. On the other hand, it should be noted that the calculator on which the neural network is implemented is a priori different from the calculator 10. The following paragraphs aim to describe the calculator 10, the calculator implementing the neural network being subsequently described in connection with the optimization method.

In a variant, the calculator on which the neural network is implemented is coalesced with the calculator 10.

The calculator 10 is preferentially a computer.

More generally, the calculator 10 is an electronic calculator suitable for handling and/or transforming data represented as electronic or physical quantities in calculator 10 registers and/or memories in other similar data corresponding to physical data in memories, registers or other types of display, transmission or storage devices.

The calculator 10 interacts with the computer program product 12.

As illustrated in FIG. 1, the calculator 10 comprises a processor 14 comprising a data processing unit 16, memories 18 and an information medium reader 20. In the example illustrated in FIG. 1, the calculator 10 comprises a keyboard 22 and a display unit 24.

The computer program product 12 comprises an information medium 26.

The information medium 26 is a medium readable by the calculator 10, usually by the data processing unit 16. The readable information medium 26 is a medium suitable for storing electronic instructions and apt for being coupled to a bus of a computer system.

As an example, the readable information medium 26 is a diskette or a floppy disk, an optical disk, a CD-ROM, a magneto-optical disk, a ROM, a RAM, an EPROM, an EEPROM, a magnetic card or an optical card.

The computer program 12 containing program instructions is stored on the information medium 26.

The computer program 12 can be loaded on the data processing unit 16 and is suitable for leading to the implementation of a method for optimizing the operation of a calculator implementing a neural network, when the computer program 12 is implemented on the processing unit 16 of the calculator 10.

The operation of the calculator 10 will now be described with reference to FIG. 2, which schematically illustrates an example of implementation of a method for optimizing the operation of a calculator implementing a neural network, and to FIGS. 3 to 11 which illustrate different examples of implementation of the steps of such a method.

The optimization method is implemented by the calculator 10 in interaction with the computer program product, i.e. is implemented by a computer.

The optimization method comprises a step 100 of providing a neural network. The neural network has parameters the w values of which, can be modified during a training of the neural network as described hereinafter.

A neural network is a set of neurons. The neural network comprises an ordered succession of layers of neurons, each of which takes the inputs thereof from the outputs of the preceding layer. More precisely, every layer comprises neurons taking the inputs thereof from the outputs of the neurons of the preceding layer.

In a neural network, the first layer of neurons is called the input layer while the last layer of neurons is called the output layer. The layers of neurons interposed between the input layer and the output layer are layers of hidden neurons.

Every layer is connected by a plurality of synapses. Every synapse has a parameter, also called synaptic weight. As mentioned above, the values w of the synapse parameters can be modified during a training of the neural network.

Every neuron is apt to perform a weighted sum of the values received from the neurons of the preceding layer, every value then being multiplied by the respective synaptic weight, and then to apply an activation function, typically a non-linear function, to said weighted sum, and to deliver to the neurons of the next layer, the value resulting from the application of the activation function. The activation function makes it possible to introduce a non-linearity in the processing performed by every neuron. The sigmoid function, the hyperbolic tangent function, the Heaviside function, the Rectified Linear Unit function (more often referred to as ReLU) are examples of activation functions.

The optimization method comprises a step 110 of providing training data relating to the values w taken by the parameters of the neural network during a training of the neural network on at least one test database.

Preferentially, the training data comprise at least the values w taken by the neural network parameters at the end of the neural network training (i.e. the final values obtained for the parameters).

Depending on the applications, the training data further comprise the values w taken by the neural network parameters during the training of the neural network on the test database. In this way it is possible to deduce a frequency of change and/or an amplitude of change of the values w of the parameters of the neural network during training.

The test database includes e.g. data from a generic application (generic database), and other data from particular applications (application databases).

The optimization method comprises a step 120 of determining, depending on the training data, an implementation of the neural network on hardware blocks of a calculator so as to optimize a cost relating to the operation of said calculator implementing the neural network. The implementation of a neural network on a calculator refers to the assignment of calculator hardware blocks for carrying out operations on the neural network.

The implementation is determined by decomposing the values w of the neural network parameters into sub-values w₀, . . . , wₚ and by assigning to each sub-value w₀, . . . , wₚ, at least one hardware block from a set of hardware blocks of the calculator. Typically, the decomposition is such that the application of a function on the sub-values w₀, . . . , wₚ of each decomposition, makes it possible to obtain the corresponding value w of the parameter.

Preferentially, the values w of every parameter are each suitable for being represented by a sequence of bits. Every bit in a sequence has a different weight depending on the position of the bit in the sequence. The bit having the greatest weight is called the most significant bit. The sub-values w₀, . . . , wₚ resulting from the same decomposition each being represented by a sequence of one or more bits such that the most significant bit is different for every sub-value w₀, . . . , wₚ. In other words, every sub-value w₀, . . . , wₚ contributes differently to the corresponding value w of the parameter.

Preferentially, the cost to be optimized uses at least one performance metric of the calculator. The optimization then aims to optimize such metric, i.e. either to maximize or minimize the metric depending on the nature of the metric. The at least one performance metric is preferentially chosen from: the latency of the calculator on which the neural network is implemented (to be minimized), the energy consumption of the calculator on which the neural network is implemented (to be minimized), the number of inferences per second during the inference of the neural network implemented on the calculator (to be maximized), the quantity of memory used by all or part of the sub-values of the decomposition (to be minimized), and the surface area after manufacture of the integrated circuit (“chip”) embedding the calculator (to be minimized).

Preferentially, the assignment of every hardware block to a sub-value w₀, . . . , wₚ is done according to the position of the hardware block in the calculator and/or of the type of the hardware block among the hardware blocks performing a storage function and/or of the type of the hardware block among the hardware blocks performing a calculation function, which is done so as to optimize the cost of the operation.

The position of the hardware block in the calculator defines the access cost of the hardware block. For two identical memories e.g., the memory furthest from the calculator calculation unit has a higher access cost than the other memory which is closer.

The hardware blocks performing a storage function have, e.g., a different type according to the reconfiguration rate thereof and/or to the accuracy thereof. ROMs e.g. have a lower reconfiguration rate than memories such as SRAM, DRAM, PCM or OXRAM type memories. The hardware blocks performing the storage function can also be the calculator as such, which, in such case, is materially configured for performing an operation between a variable input value and a constant (which takes the value of the decomposition element).

The hardware blocks performing a calculation function have e.g. a different type depending on the nature of the calculation performed, e.g., matrix calculation versus event-driven calculation (also called “spike” calculation).

In an example of implementation, every value w of a parameter results from the addition of the sub-values w₀, . . . , wₚ of the corresponding decomposition. In such case, every value w of a parameter results from the sum of a sub-value w₀, the so-called basis weight, and other sub-values w₁, . . . , wₚ, so-called perturbations. Every sub-value w₀, . . . , wₚ is then represented by a number of bits equal to or different from the other sub-values w₀, . . . , wₚ. In particular, the basic weight is typically represented by the largest number of bits.

Such a decomposition allows the sub-values w₀, . . . , wₚ to be represented by an integer, a fixed point or further a floating point. In such case, conversions are applied for making the representations of the different sub-values w₀, . . . , wₚ uniform at the time of addition.

The addition decomposition, like the other types of decomposition described below, gives the possibility of using different memories for the storage of the sub-values w₀, . . . , wₚ of the same decomposition. If e.g. the values w of the parameters are often modified by low values which can be represented on a few bits, a memory with low precision with high write efficiency is of interest for storing the sub-values w₀, . . . , wₚ corresponding to such variations. The other sub-values w₀, . . . , wₚ are typically implemented in memories with low read consumption and potentially less write efficiency, because the sub-values w₀, . . . , wₚ are read often, but rarely modified. PCMs are e.g. memories with low read consumption, but high power consumption/limited write cycles. ROMs are memories with low read consumption, but high write consumption, which are fixed during the manufacture of the chip.

It should also be noted that memories can have different physical sizes or different manufacturing costs. E.g. a memory is used for base weights with a high but very small write cost (so more can be put on the same silicon surface) or very easy/not expensive to manufacture/integrate into a standardized production process. The number of possible levels can also be a factor. PCMs e.g. can often represent just 1 or 2 bits with sufficient reliability.

In a variant, the same type of memory is used for all sub-values w₀, . . . , wₚ of the decomposition, and the access costs differ only in the complexity of access. E.g. a small memory close to the calculation unit will be fast and less expensive to access, than a large memory further from the calculation unit but saving a larger number of bits. Such differences in the cost of access are e.g. due to the resistance of the connection cables, or to the type of access (memory directly connected to the calculator by cables versus complex addressing system and data bus requiring address calculations or introducing waiting times).

A specific advantage of addition decomposition, compared to concatenation decomposition, is to more easily use different types of representations for sub-values. E.g. integer/fixed-point/floating-point values or physical quantities (current, charge) can be used which may not be in binary format.

FIG. 3 illustrates an example of addition decomposition of a value w of a parameter, represented on 8 bits, into three sub-values, namely: a basic weight w₀, represented on 8 bits, a first perturbation w₁ represented on 3 bits and a second perturbation w₂ represented on 1 bit.

In another example of implementation, every value w of a parameter results from the concatenation of the sub-values w₀, . . . , wₚ of the corresponding decomposition. In such case, every value w of a parameter results from the concatenation of a sub-value w₀, called base weight, and of other sub-values w₁, . . . , wₚ, called perturbations. Every sub-value w₀, . . . , wₚ then corresponds to most significant bits different from the other sub-values w₀, . . . , wₚ. Concatenation is performed starting with the base weight and then with the perturbations in the order of significance of the perturbations. Such a decomposition allows the sub-values w₀, . . . , wₚ to be represented by an integer or a fixed point.

In addition to the above-mentioned advantages with the addition decomposition and which are applicable to the concatenation decomposition, concatenation decomposition gives the possibility of using different calculation units for every sub-value w₀, . . . , wₚ of the decomposition. E.g. for an integer n-bit sub-value w₀, . . . , wₚ, an integer n-bit multiplier is used. The type of calculation unit used can also be different. E.g. it is possible to use a calculation unit optimized for operations on the sub-values with the greatest contribution (in particular the base weight), and a different calculation unit optimized for operations on the sub-values with low contribution, such as event-driven calculation units. Event-driven calculation units are particularly of interest if the sub-values are rarely changed and are often zero.

FIG. 4 shows an example of concatenation decomposition of a value w of a parameter, represented on 8 bits, into three sub-values, namely: a basic weight w₀ represented on 5 bits, a first perturbation w₁ represented on 2 bits and a second perturbation w₂ represented on 1 bit.

In yet another example of implementation, every value w of a parameter results from a mathematical operation on the sub-values w₀, . . . , wₚ of the corresponding decomposition. Such operation is e.g. embodied by a function F having as inputs the sub-values w₀, . . . , wₚ of the decomposition and as output the value w of the parameter. The mathematical operation is e.g. the multiplication of the sub-values w₀, . . . , wₚ for obtaining the value w of the parameter. In another example, the mathematical operation is an addition or a concatenation according to the above-described embodiments. Thus, such example of implementation is a generalization of the addition decomposition or of the concatenation decomposition.

In a first example of application, the cost to be optimized uses at least one performance metric (latency, energy consumption) of the calculator implementing the neural network, which happens during a subsequent training of the neural network on another database. The first application thus aims, to optimize the performance of the calculator during a subsequent training phase of the neural network. Such a first application is of interest in a scenario of real-time adaptation of the neural network during which the values w of the parameters of the neural network are permanently modified according to the data provided to the learning system.

In the first example of application, the training data comprise both the values w taken by the neural network parameters at the end of the training on the test database (i.e. the final values obtained for the parameters), and the other values w taken by the neural network parameters during the neural network training on the test database. The test database typically comprises data similar to or representative of the data that the neural network will receive during the execution thereof on the calculator.

The initial values of the neural network parameters during subsequent training are defined according to the training data and typically correspond to the final values obtained after training.

In the first example of application, the decomposition of the values w of the parameters into sub-values w₀, . . . , wₚ is then determined according to the frequency of change and/or the amplitude of change of said values w in the training data. The hardware blocks assigned to every sub-value w₀, . . . , wₚ are also chosen so as to optimize the operating cost. Typically, when memories are assigned to the sub-values w₀, . . . , wₚ, the assignment is performed according to the contribution of the sub-value w₀, . . . , wₚ to the corresponding value of the parameter. Memories with a low access cost (close to the calculation unit) or a low reconfiguration rate are typically assigned to sub-values with a large contribution, since said sub-values are more often read (in training or inference) and less often modified. However, memories with a low access cost potentially have a high write cost, as is the case for ROMs. Thus, memories with a low write cost (but which hence potentially have a higher access cost) or a high reconfiguration rate are typically assigned to sub-values with a lower contribution, since said sub-values are more often modified than the other sub-values. Thus, in the first example, it is accepted to have a higher read cost so as to have a low write cost for types of memories when the sub-values w₀, . . . , wₚ are often modified.

In the example of FIGS. 3 and 4 e.g., a ROM (low read cost, high write cost) is assigned to the base weight w₀, a PCM (higher read cost, lower write cost) Is assigned to the first perturbation w₁, and a FeRAM (potentially even higher read cost, even lower write cost) is assigned to the second perturbation w₂.

In a second example of application, the cost to be optimized uses at least one performance metric (latency, energy consumption) of the calculator implementing the neural network, which happens during a subsequent inference of the neural network on another database. The second application thus aims to optimize the performance of the calculator during a transfer learning process. Given a generic database and one or a plurality of application databases, the goal herein is to achieve optimized performance for all application databases.

In the second example of application, the training data comprise both the values w taken by the neural network parameters at the end of the training on the test database (i.e. the final values obtained for the parameters), and the other values w taken by the neural network parameters during the neural network training on the test database. The test database typically comprises generic and application data for evaluating the impact of the application data on the modification of the values w of the neural network parameters. The initial values of the neural network parameters during a subsequent training are defined according to the training data and typically correspond to the final values obtained after the training on the generic data of the test database.

In the second example of application, the decomposition of the values w of the parameters into sub-values w₀, . . . , wₚ is then determined according to the frequency of change of said values w and/or of the amplitude of change of said values w in the training data, in particular when using application data (transfer learning). The hardware blocks assigned to every sub-value w₀, . . . , wₚ are also chosen so as to optimize the operating cost.

E.g. part of the sub-values of the decomposition is fixed (hardwired in the calculator). In such case, the decomposition is chosen so that a sufficiently large number of application cases can be processed with the same fixed sub-values. Fixing some of the sub-values improves the latency and/or the energy consumption of the calculator. Optimization consists in finding a balance between performance optimization and adaptability to all application databases. Indeed, if a too large portion of the sub-values is fixed, it will not be possible to sufficiently modify the sub-values of the decomposition so as to adapt the neural network to a sufficiently large number of application cases.

Typically, exactly like for the first example of application, when memories are assigned to the sub-values, the assignment is e.g. performed according to the contribution of the sub-value to the corresponding value w of the parameter. Memories with a low access cost (close to the calculation unit) or a low reconfiguration rate are typically assigned to sub-values with a large contribution, since said sub-values are less often used (in training or inference) and less often modified. However, memories with a low access cost potentially have a high write cost, as is the case for ROMs. Thus, memories with a low write cost (but which hence potentially have a higher access cost) or a high reconfiguration rate are typically assigned to sub-values with a lower contribution, since said sub-values are more often modified than the other sub-values.

More specifically, in the second example of application, the assignment is done e.g. by determining the sub-values to be fixed. However, it is generally not useful to change the weight after training on the application base, hence the write efficiency is less important than for the first example application.

It is also stressed that the different application cases can also be combined in the same system. One could e.g. perform the continuous learning of the first application example on a system with fixed sub-values of the ‘transfer learning’ scenario. In such case, sufficient reconfigurability will be sought at the same time as an efficiency in such reconfiguration. In a third example of application, the cost to be optimized uses at least one performance metric of the calculator implementing the neural network during an inference of the neural network by considering only a part of the sub-values of every decomposition. The values w of the neural network parameters were fixed in such case according to the training data.

The third application thus aims to achieve an adjustable precision inference. The decomposition of the values w of the parameters into sub-values w₀, . . . , wₚ is determined in particular according to the contribution of said sub-values w₀, . . . , wₚ to the corresponding value w of the parameter. Typically, the idea is to use, during the inference phase, only the sub-values with the greatest contribution to the corresponding value w of the parameter, or even only the sub-value represented by the most significant bit. Such sub-values are then assigned memories with low access cost or with features enhancing the read. Inference calculations are then performed only on said sub-values. In this way it is possible to perform an approximate inference with optimized performance (low consumption/latency).

If better calculation precisions are required, and a higher consumption/latency is accepted, other sub-values of the decomposition are taken into account in the calculations. This is e.g. the case in a method for recognizing elements on an image (rough processing, then fine processing). Such sub-values are typically assigned to memories with a higher access cost and/or read features which are less optimized than the most significant sub-values. Such assignments can nevertheless have other advantages, e.g. having a lower write cost if the third application example is combined with one of the other cases of use which requires regular rewrite (in particular the first application example).

In the third application example, the training data comprise the values w taken by the neural network parameters at the end of the training on the test database (i.e. the final values obtained for the parameters). The values w of the parameters of the neural network correspond in such case to the final values.

At the end of the determination step 120, a calculator is obtained, which has hardware blocks (memory, calculation unit) assigned to the sub-values w₀, . . . , wₚ of the decompositions so as to optimize a performance metric (latency, energy consumption) of the calculator. To this end, where appropriate, the calculator is configured beforehand, or even manufactured on the basis of the hardware blocks assigned to the sub-values w₀, . . . , wₚ of the decompositions.

The optimization method comprises a step 130 of operating the calculator with the implementation determined for the neural network.

The operation corresponds to a training or inference phase of the neural network. In operation, calculations are performed on the sub-values wₚ of every decomposition according to data received at input by the neural network.

In an example of implementation, during the operation step, the sub-values w₀, . . . , wₚ of every decomposition are each multiplied by an input value and the results of the resulting multiplications are summed (addition decomposition) or accumulated (concatenation decomposition) for obtaining a final value. Every final value obtained is then used for obtaining the output or outputs of the neural network.

FIG. 5 illustrates an example of multiplication of every sub-value w₀, w₁ and w₂ by an input value X, followed by an addition of the resulting multiplications. FIG. 6 illustrates an example of multiplication of each sub-value w₀, w₁ and w₂ by an input value X, followed by a concatenation of the resulting multiplications, the resulting multiplications having been converted (shifted) beforehand according to the bits corresponding to the sub-values.

In another example of implementation, during the operation step, the sub-values w₀, . . . , wₚ of every decomposition are summed (addition decomposition) or concatenated (concatenation decomposition) and the resulting sum or concatenation is multiplied by an input value for obtaining a final value. Every final value obtained is then used for obtaining the output or outputs of the neural network.

FIG. 7 shows an example of addition of every sub-value w₀, w₁, and w₂ and of multiplication of the resulting sum to an input value X. FIG. 8 shows an example of concatenation of the sub-values w₀, w₁, and w₂ and of multiplication of the resulting concatenation to an input value X.

More generally, as illustrated by FIG. 9, during the operation step, the sub-values w₀, . . . , wₚ of every decomposition are taken as input of a function F the output of which is an intermediate value corresponding to the value w of the parameter resulting from the decomposition (decomposition resulting from a mathematical operation). The intermediate value is then multiplied by an input value for obtaining a final value. Every final value obtained is then used for obtaining the output or outputs of the neural network. When the operation comprises a training of the neural network, the sub-values w₀, . . . , wₚ of every decomposition are updated during the training.

In the case of an addition decomposition, a decomposition of the variation Δw of the value w of the parameter is determined so as to optimize the cost of updating the corresponding sub-values w₀, . . . , wₚ of the parameters. Such a decomposition for updating is illustrated in FIG. 10. For this purpose, the updating is e.g. performed according to the access cost of the different memories on which the sub-values w₀, . . . , wₚ are stored. E.g. depending on the case, it is preferable to update a large memory with a high access cost, so as to avoid updating two memories, each with a lower access cost, but a higher sum of access costs. In the general case, the cost to be optimized for the update is the sum of all the memory access costs which are modified. Preferentially, to avoid a complex optimization of the access procedure, heuristic methods are used. In most cases, however, it would be more logical to modify the sub-values according to the access cost thereof, since in practice, the modifications of the values w of the parameters will be relatively small, and will only affect the lower order perturbations.

The update presented for addition decomposition also applies to the generic case of decomposition resulting from a mathematical operation, as described above.

In the case of concatenation decomposition, the value of the variation Δw of the parameter is e.g. simply added bit by bit starting with the least significant bits. A communication mechanism between the memories on which the sub-values w₀, . . . , wₚ are stored, makes it possible to communicate the transfer of bits to bits. Such an update is illustrated in FIG. 11.

Thus, the present method makes it possible to obtain an automatic learning system for which the parameters which can be trained are divided into a plurality of sub-values, the sub-values w₀, . . . , wₚ then being processed by hardware blocks (memories, calculation units) chosen so as to optimize the performance of the calculator. Such a method can thus be used for optimizing the performance of machine learning systems implementing a neural network.

In particular, for real-time adaptation applications of the neural network (first application) and transfer learning applications (second application), the present method makes it possible to use the fact that the values w of the network parameters are only slightly modified by small perturbations. Such small perturbations are typically much lower in terms of dynamics than the initial value of the parameter, have different statistical features, and modification frequencies potentially higher than the base weights.

Such a method is also of interest for applications such as approximate inference (third application), thus making it possible to optimize the performance of the calculator when an approximate precision in the output data is acceptable.

In particular, the present method enables MAC type operations to be executed in an optimized manner through a decomposition of the values w of every parameter into a plurality of sub-values w₀, . . . , wₚ, and by performing an optimized MAC operation on each of said sub-values. For this purpose, an optimized calculation or storage unit is e.g. chosen for every sub-value w₀, . . . , wₚ of the decomposition.

A person skilled in the art will understand that the embodiments and variants described above can be combined so as to form new embodiments provided that same are technically compatible.

1. A method for optimizing operation of a calculator implementing a neural network, the method being implemented by a computer and comprising the following steps:
providing a neural network, the neural network having parameters, values of which can be modified during a training of the neural network,
providing training data relating to the values taken by the neural network parameters during a training of the neural network on at least one test database,
determining, depending on the training data, an implementation of the neural network on hardware blocks of the calculator so as to optimize a cost relating to the operation of said calculator implementing the neural network, the implementation being determined by decomposing the values of the neural network parameters into sub-values and by assigning to every sub-value, at least one hardware block from a set of hardware blocks of the calculator, and
operating the calculator with the implementation determined for the neural network.

2. The method according to claim 1, wherein the values of every parameter are each suitable for being represented by a sequence of bits, every bit of a sequence having a different weight according to the position of the bit in the sequence, the bit having the greatest weight being called the most significant bit, the sub-values resulting from the same decomposition being each represented by a sequence of one or a plurality of bits.

3. The method according to claim 2, wherein every value of a parameter results from a mathematical operation, such as an addition, a concatenation or a multiplication, on the sub-values of the corresponding decomposition.

4. The method according to claim 1, wherein, during the operation step, the sub-values of every decomposition are each multiplied by an input value and the results of the resulting multiplications are summed or accumulated for obtaining a final value, the output or outputs of the neural network being obtained according to the final values.

5. The method according to claim 1, wherein, during the operation step, a mathematical operation is applied to the sub-values of every decomposition so as to obtain an intermediate value, the intermediate value being the value of the parameter corresponding to the decomposition, the intermediate value being then multiplied by an input value for obtaining a final value, the output or outputs of the neural network being obtained according to the final values.

6. The method according to claim 5, wherein the mathematical operation is an addition, a concatenation or a multiplication of the sub-values of every decomposition so as to obtain the value of the corresponding parameter.

7. The method according to claim 1, wherein the cost to be optimized uses at least one performance metric of the calculator implementing the neural network during a subsequent training of the neural network on another database, the initial values of the neural network parameters during a subsequent training being defined according to the training data.

8. The method according to claim 1, wherein the cost to be optimized uses at least one performance metric of the calculator implementing the neural network during a subsequent inference of the neural network after a subsequent training of the neural network on another database, the initial values of the neural network parameters during subsequent training being defined according to the training data.

9. The method according to claim 1, wherein the training data comprise the different values taken by the parameters during the training on the at least one test database, the decomposition of the values of the parameters into sub-values being determined according to the frequency of change and/or the amplitude of change of said values in the training data.

10. The method according to claim 1, wherein the cost to be optimized uses at least one performance metric of the calculator implementing the neural network during an inference of the neural network by considering only a part of the sub-values of every decomposition, the values of the neural network parameters having been set according to the training data.

11. The method according to claim 1, wherein the cost to be optimized uses at least one performance metric of the calculator, the at least one performance metric being chosen from: the latency of the calculator on which the neural network is implemented, the energy consumption of the calculator on which the neural network is implemented, the number of inferences per second during the inferences of the neural network implemented on the calculator, the quantity of memory used by all or part of the sub-values of the decomposition, and the surface area after manufacture of the integrated circuit embedding the calculator.

12. The method according to claim 1, wherein the assignment of every hardware block to a sub-value is performed according to the position of the hardware block in the calculator and/or to the type of the hardware block among the hardware blocks performing a storage function and/or to the type of the hardware block among the hardware blocks performing a calculation function.

13. (canceled)

14. A non-transitory computer-readable medium on which a computer program product comprising program instructions is stored, the computer program being loaded into data processing circuitry and leading to the implementation of a method according to claim 1 when the computer program is implemented on the data processing circuitry.
